(19) United States
(12) Patent Application Publication
(10) Pub. No.: US 2025/0272427 A1
(43) Pub. Date: Aug. 28, 2025

(54) Apparatus and method for a decentralized platform to allow users to own, control, and monetize their data

(71) Applicant: Sumit P. Ahuja, New York, NY (US)

(72) Inventor: Sumit P. Ahuja, New York, NY (US)

(21) Appl. No.: 17/803,726

(22) Filed: Oct. 29, 2022

Related U.S. Application Data
(60) Provisional application No. 63/263,424, filed on Nov. 2, 2021.

(51) Int. Cl. G06F 21/62

(52) U.S. Cl. CPC G06F 21/6245

(57) ABSTRACT

An apparatus and method for users to store, attest, verify, exchange and share information and data without a need of centralized service while ensuring the users data is controlled and stored by the user on their owned mobile devices. Preferably, users have the ability for selective attribute, data and information disclosure while ensuring the end recipient always gets the latest updated information state at any given time. Information and data will be secured, encrypted by the user owned cryptographic keys and will not expose the data to operators of the decentralized network while optionally ensuring that the user data and information can also be stored in non-searchable, non-relatable, non-traceable and non-transferable private state mutable storage engine. A private state mutable storage engine is available to all the decentralized network providers, making it a unique decentralized user encrypted, controlled data and state backup service. User's private identifiable information (Pii) is not in any decentralized storage, not even in the form of encrypted data to ensure the solution is Quantum computing proof.

### BACKGROUND OF THE INVENTION

The existing information technology services are either owned by Central Authorities or owned by a single or group of Organizations. Most of the commercial Platforms and Applications are owned and managed by Centralized organizations which people use in our everyday activities which leaves them exposed, users information such as location services and device identity are in the control of these organizations. This allows the organization to use the data of the end user to for Ad Targeting based on Activity and Interests.

Communication services such as messaging that users use are controlled by centralized authorities and data is used with or without user consent for marketing purposes based on the personal data. If the data itself is not completely encrypted when there is a major data leak or hack, the users data get exposed over the internet, While there are organizations tries their best to ensure encryption of data, large scale data leaks due to hack events because the encryption mechanism is centralized. Losing access to centralized encryption key causes disruption for all the millions of users globally.

Authentication and authorization systems used today are also controlled by relevant central authorities, leaving the end users to depend on available recovery mechanisms, there is no standard protocol and policy which provides greater authority to the identity owner to retrieve them. Most of these recovery systems require Personal Information to be available to the service provider to prove ownership and regain access, some of this information would include phone number, e-mail address and address etc. While there are other known recovery methods such as soft token using two factor or mobile OTP these do not remain viable if a user loses access to the mobile device or the number itself. Moreover these credentials cannot be used across “all” the other central authorities unless the end service has chosen to implement/integrate the solution.

Users use data services such as image storage, document storage and contacts storage, etc. These services are managed and controlled by a centralized authority allowing the service provider to use for various purposes such as analytics, Vision AI and Marketing. The documents stored are not encrypted by instead using centralized encryption mechanisms for data at rest, as we have discussed earlier the loss of a single source of encryption mechanism or key would result in large scale disaster.

All or most of the services that the users use are controlled by a central authority and the privacy of the user is in the hands of the service providers running them. Now that we have understood the services let us see the core problems around them:
Centralization
Data Privacy
Data Ownership
No universal Identity
Service Provider in Control

The current invention builds a protocol, framework and ECOSystem to solve these problems. There are various individuals and organizations working towards achieving self sovereign identity and decentralizing it without success. Ethereum was launched in July 2015 with a goal to build a platform that would allow the development of Decentralized Apps also known as DApps, This platform use blockchain technology as core functionality and allows to execution of contracts (a program or functionality) using EVM (Ethereum Virtual Machine) along with financial ability to transact using a digital currency which is well known today as crypto currency. As the adoption of DApp grew across industry the Ethereum network could not withstand the contract execution in a timely manner due to the lack of capability to scale because of the current proof of work consensus.

Proof of work consensus allows individuals and organizations to run a node and join Ethereum network and get rewarded through mining, which means the horizontal scaling was possible however the amount of power used across the network grew to massive amount resulting in higher gas fees or wait time for standard transitions to go through which eventually became a bottleneck for wider adoptions considering most of the general public would not prefer paying for using DApp when there are pre existing centralized that do not need a fees to be used.

Now the fee can either be borne by the service provider or the end user but either way high transaction fee or higher wait time would also prove the service to be non performant. As the bottleneck of Ethereum scalability grew, many of the DApps chose to integrate Layer 2 Scaling mechanisms/solutions to reduce the Gas fee and higher wait times causing the DApp to either eventually centralized or become a decentralized distributed platform. Layer 2 scaling is a solution built on top of core services or integrated with core services such as off chain data storage, data transport layers etc.

Now these result in two major problem depending on the layer 2 scaling type used:
Controlled Data in case layer 2 is centralized
Duplicate data in case the DApp chose to become Decentralized distributed platform When a DApp chooses to integrate a solution such as database for data storage which is not decentralized, the end users data may be encrypted but still in the control of the service provider. While the end user can download the data in some of the DApps, the data structure would not necessarily be standard across all the DApp providers thus making the user data irrelevant for future use.

When a DApp chooses to use a decentralized service to offload the data to another decentralized service this causes the data to become decentralized distributed data. While this may seem very much acceptable for the service to run but for end user this will cause duplication of data across various DApp platforms, for example a user who has already signed up for a DApp “A” using Ethereum and has data stored in IPFS would not necessarily be able to move it DApp “B” unless there is a facility within the application that follows the same logic and data structure. This causes the user to create multiple profiles and data across multiple DApp providers. Most of this digital decentralized identity doesn't have a mechanism to interface with other services on it's own and it is purely an identity. When we talk about interfaces for example using the existing decentralized identity built using Ethereum won't be able to use same identity to access the bitcoin, this is sorted by most of the services by adding a functionality called resolvers to use relevant credential under the decentralized identity to be used, however not all DApp's as on date supports them.

Decentralized Data service exists today and is very promising overall, IPFS is one of those services that supports decentralized data storage however lacks few crucial functionalities such as identifiable, searchable content. There are ongoing solutions looked at to solve this problem however it is far away from becoming reality in near future. IPFS solves the majority of the data decentralization issue and is widely used by various DApps but definitely brings in the problem of duplication, DDOS, etc.

### SUMMARY

The current invention provides a solution where the user controls their data, has the ability to selectively, share, attest, verify and update information, data and state as needed without any centralized service. User's unencrypted version of information, data and state, also which can be considered the source of truth remains on users control on their chosen devices and pushes the latest encrypted version of that information decentralized on private encrypted Main Stack solution across various providers.

The encrypted information, Data and state push to Main Stack should not be publicly accessible to ensure the encrypted content is Quantum Computing proof while ensuring the content non-searchable, non-relatable, non-traceable and non-transferable private state mutable storage engine. A global unique naming convention for the users identity which doesn't necessarily disclose the Pii of the user, This identity can be used as a resolver across services such crypto public address, web profile etc.

This solution allows users to verify their claims without disclosing their Private Identifiable information using decentralized user owned contracts.
1. Provide the user to control and choose whether or not to monetize using their private data and how, to who and to what extent they would like to share such information.
2. Allow users to encrypt and store in a mutable storage engine while making sure the data is non-searchable, non-relatable, non-traceable and non-transferable private state mutable storage engine, The unique content identifiers to be stored in user owned private contracts on Main Stack Providers.
3. Allows the user to restore the information, state and data on any device as long as they can prove the ownership of data using cryptographic private keys owned and stored by users.
4. Allow users to use the Main Name as Cryptocurrency wallet resolver.

A user should be able to deploy a decentralized identity contract which proves the ownership of chosen attributes and identities in the form of public key cryptography. The current invention, Main stack should allow decentralized consortium among providers with the help of peer to peer discovery to sync stack across providers. Users can choose the selective disclosure process in the data marketplace in exchange of crypto tokens which can be used for other utility within the network or to be exchanged for a currency.

### BRIEF DESCRIPTION OF THE DRAWINGS

FIG. 1 is a block diagram of the entire environment for the current invention.

FIG. 2 is a flow chart showing the information, data and state are stored in a non-relational manner.

FIG. 3 is a block diagram showing the flow of the frontend or the mobile interface.

FIG. 4 is a block diagram showing the location of the unencrypted data, information and state is stored.

FIG. 5 is a block diagram shows the interconnectivity between various solution components.

FIG. 6 is a block diagram of the provider stack components for user encrypted storage.

FIG. 7 is a diagram of a custom Ethereum public blockchain.

FIG. 8 is a diagram of the custom IPFS public gateway and Public IPFS.

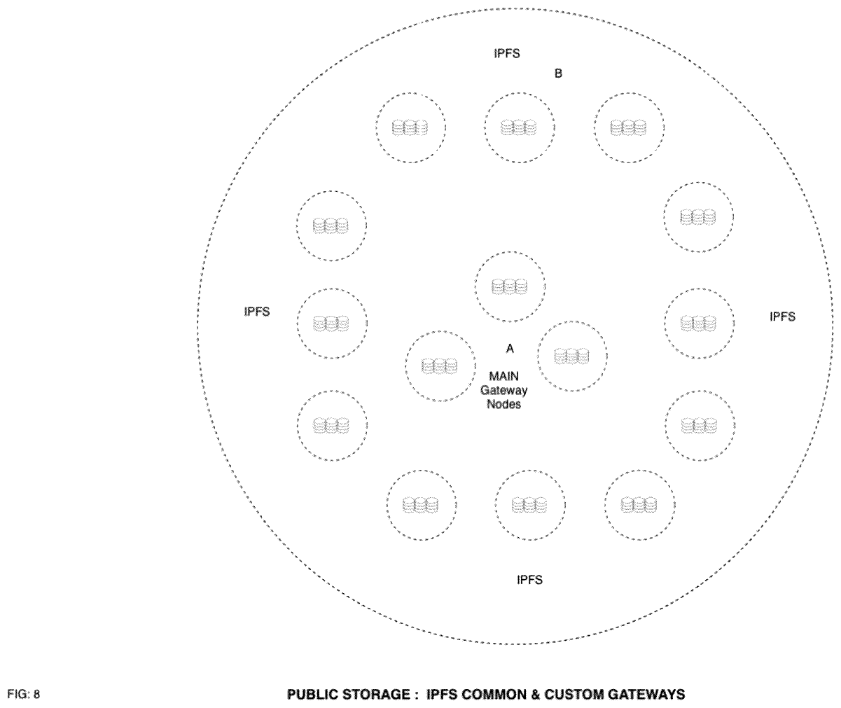

FIG. 9 is a diagram of user friendly identity: format

FIG. 10 is a diagram of user account encryption key: generation

FIG. 11 is a diagram of resolver: service

FIG. 12 is a diagram of identity contract: methods

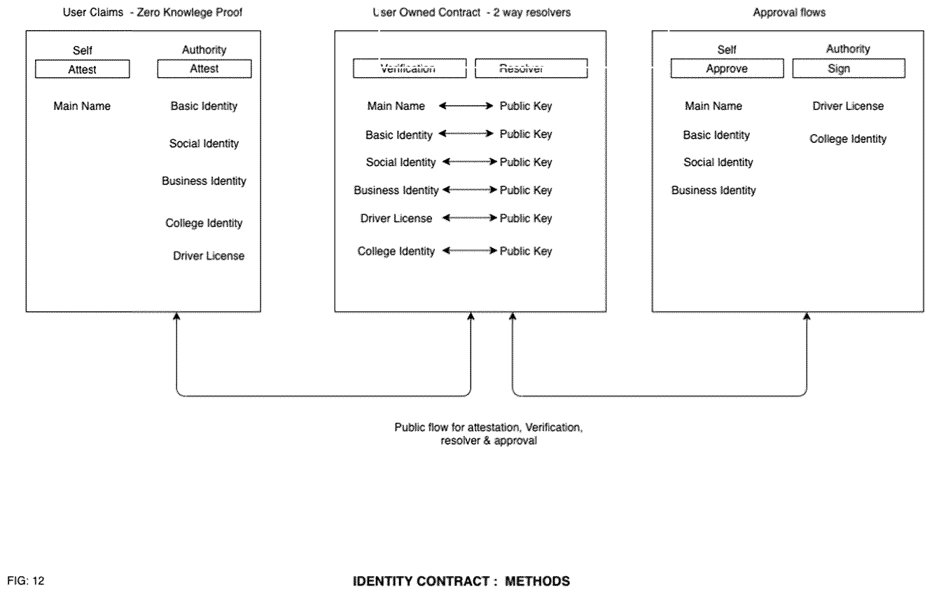

FIG. 13 is a diagram of Data & State: Lifecyle

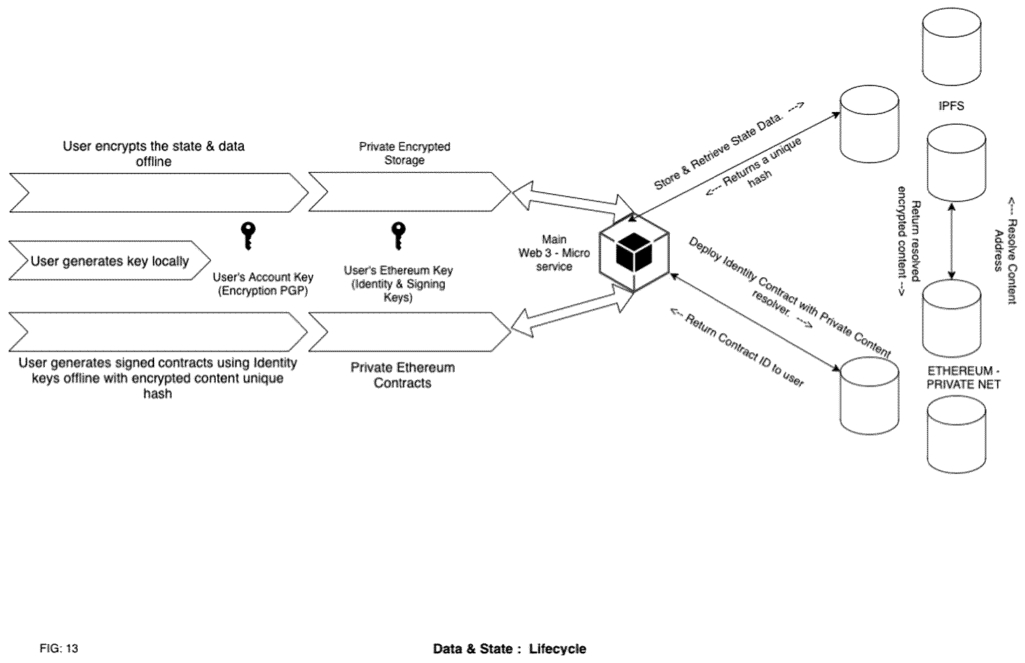

FIG. 14 is a diagram of Top level DID—Main ID

FIG. 15 is a diagram of Public Side Chain Plublic block chain

### DETAILED DESCRIPTION

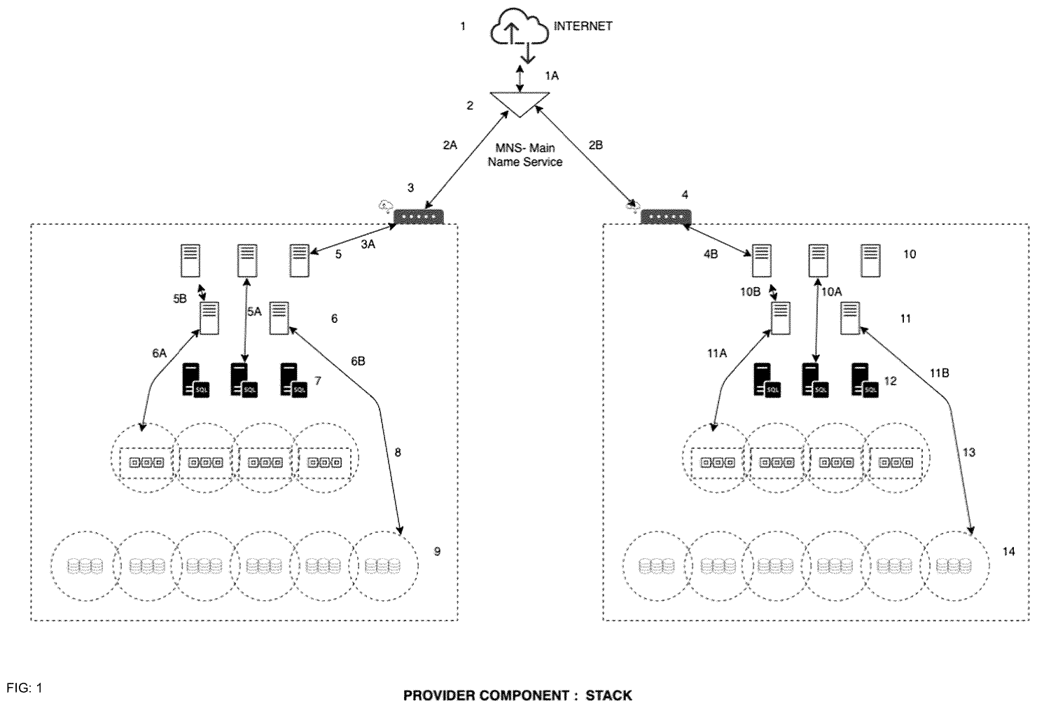

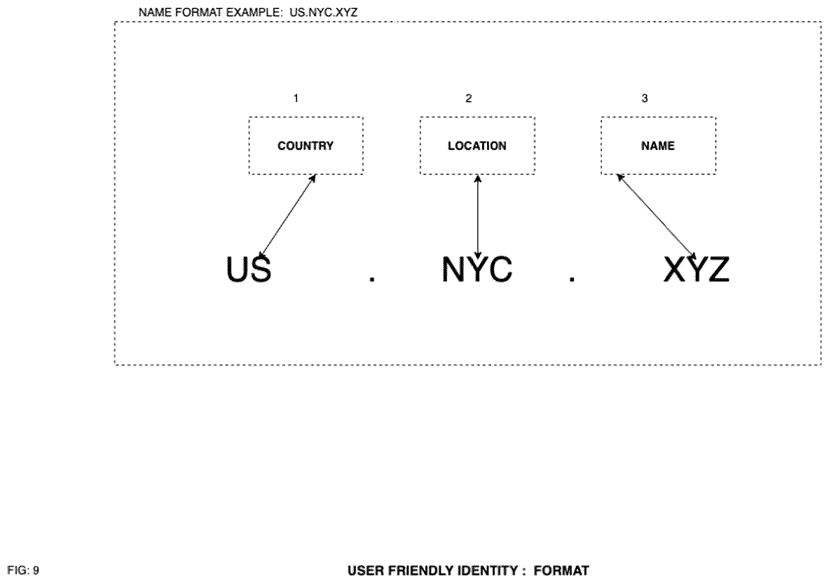

The following detailed description of the current invention. The preferred embodiment of the overall implementation process and solution is shown in FIG. 1, this diagram shows the process of the various environment components, connectivity and storage lifecycle. The Input or source of data starts from component 1 which is a user depiction shown in the diagram. In one embodiment, the user supplies the initial data, information (Pii) and state source is unencrypted. The initial process of onboarding the user which includes a unique name generation on the basis users chosen country, location and user chosen name. This format can be seen in FIG. 9, the component 1 of the name format contains country, component 2 of the name format contains the user chosen location and component 3 of the name format contains the user chosen name or identity. The user self attests the country by verifying the one time passcode verification at sign up. Rest of the location or the name can be the user's choice.

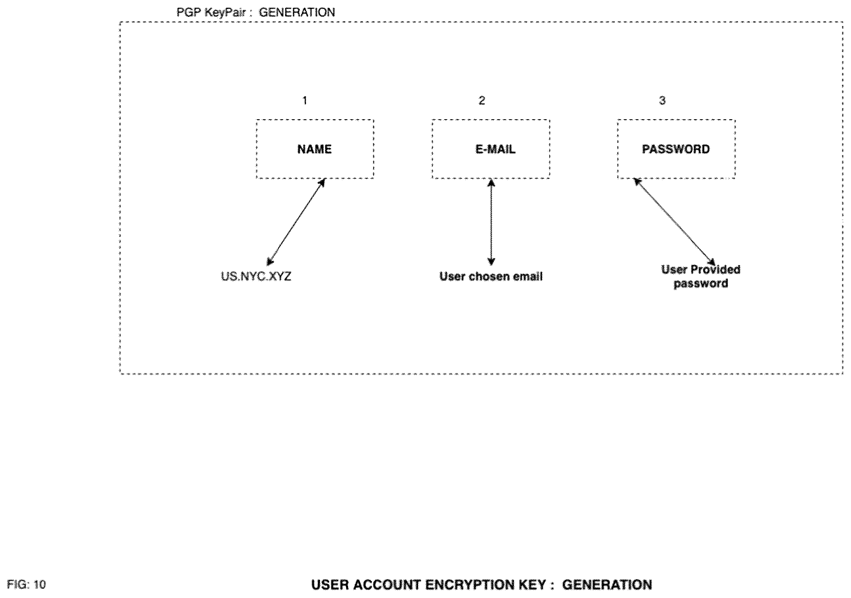

Preferably, a user at the time of sign up sets a password for login which is also used as passphrase for account encryption by generating a PGP keypair. The PGP keypair generated at the time of signup can use the unique name chosen by the user. FIG. 10 shows the key generation with inputs taken, component 1 is the user chosen unique name, component 2 user provided email address and component 3 user provided password for the account encryption key. Once the keys are generated, the user is instructed to backup the private key content safely, to import this key user's password is required.

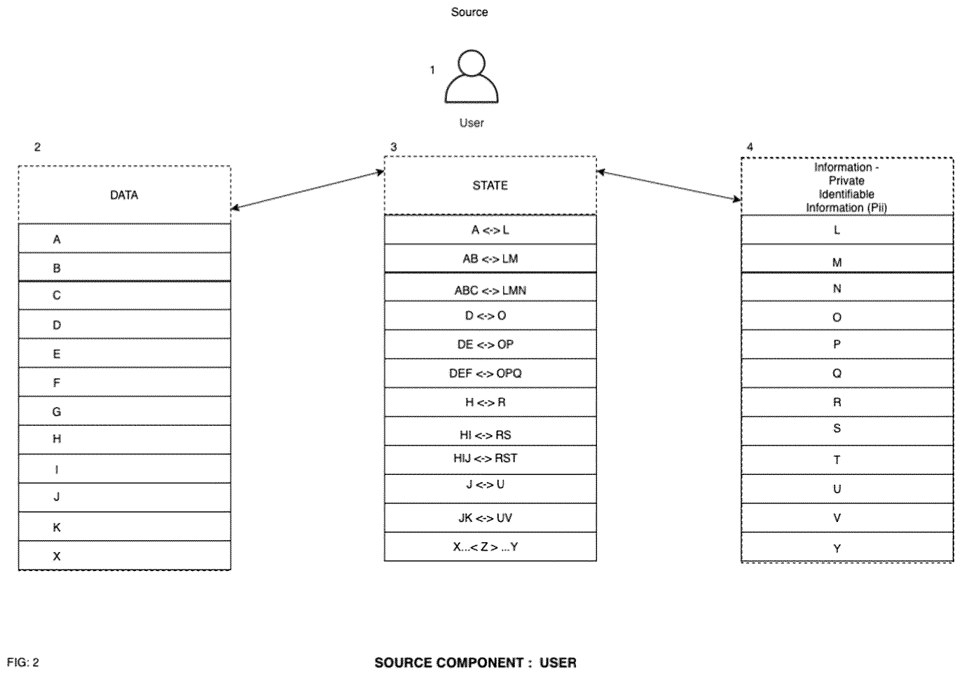

The process of bringing data from the source 1 in shown in FIG. 1 and FIG. 2. Mobile application can be installed by the user. User's basic information such as email address, mobile number, first name and last name can be taken at the onboarding stage. This information is retrieved in a user owned device 3, such as but not limited to a smart phone device. The source basic information is stored on the user's device local storage in unencrypted format in this format and thus becoming the source of truth in the data lifecycle.

The state restore process can be triggered when a user switches to a new device or removes the app from their existing device. Users can install the mobile app on their new phone and use the sign in route to restore their account details. At the time of sign in, user enters the account private key backed along with the user name, password to authenticate and restore the state from the mutable private storage available with the providers. Once the user has restored the state on the device and decrypted their data with account private key to restore the encrypted source on the mobile device.

Component 2 in FIG. 1 is the user interface of the mobile device which allows the user to store, retrieve and read information such as but not limited to: data set, information set (Pii) and State Set such as timebound information. The input flow of information from the source 1 the user to mobile interface 2 which can be done by user manually using mobile device shown in component 1A of FIG. 1, this is the initial phase of storage life cycle where the data reaches the device local storage 4 also considered as the source of truth.

In the preferred embodiment, component 2 is designed in a modular manner with some standard properties to begin with in the onboarding process it allows three data sets to be saved such as but not limited to basic information, business information and social information. These data sets contain information sets which are predefined Pii for example would have standard input set of name, email address and mobile where as in social sets it will contain social network identities along the options mentioned in the basic information set such as a separate email address and mobile number.

These information sets are encrypted using an account encryption key which is generated in the onboarding process and the initial state set is pushed as a backup to the provider stack 6. Device 3 connects to the internet to resolve any of the closest decentralized provider sets using the internet 5 this is shown in 3B. The state sets are further synced among the providers using DHT/Kademlia network with allowed stake members for example in FIG. 1 Example if the user device sent the initial state to the provider 6A then it would be further synchronized with the 6B or 6C, etc. This ensures that the state availability for restoration on a new device is available even if one provider is unavailable.

In an alternative embodiment, users have the ability to publish decentralized web profiles from the mobile interface which are deployed to IPFS 5E which is accessible from general IPFS public gateways and also the current inventions, Main's custom gateway's. Such profile deployed contains user chosen public information or cryptographic resolvers which such as but not limited to: contract addresses for identity, decentralized identity, etc.

Web profile publishing interface has a selective approach for the user to make the information public along with some information such user approved centralized identities for social networks. Users also can provide basic description or bio on the profile as needed. This web profile is available in decentralized web access and helps users to share their profile with anyone over the internet. Preferably, component 5D user owned and deployed smart contract to public blockchain which verifies identity without the need of centralized provider or service. These smart contracts are also designed with some common parameters to ensure they are the same standard for every user while the value is available in the form of public key resolvers.

The novelty of the current invention is to ensure each user has the ability to deploy a smart contract for decentralized identity, owned and controlled by said user and thus not needing a registry. This also ensures that the contract's standards can be ported to any blockchain as needed which allows users to choose where they wish to deploy the contract. The current invention, Mainchain preferably is a customized Ethereum blockchain where the difficulty calculation is eased and designed to pause unless there is a pending transaction or block to be mined thus avoiding unnecessary constant worker process runtime and faster transaction time. MainChain currency ticker is MAIN and the Main Stack running the custom private blockchain under each provider is called MainCredits.

The IPFS public node's are synced with IPFS public network this ensures the public content published is available across any Gateway including Main's Custom Gateway.

Content and information (Pii) Sets backend up on the private IPFS under the Main stack is designed to be mutable, that is the service designed to allow CRUD operations such as create, read, update and delete. This is possible by saving the data sets from User Data 2 in FIG. 2 and Private Identifiable information 4 in FIG. 2 saved together as a single state under one progressive set. Each set provides a unique content hash, this hash is further saved under users private contract under Main Stack using custom private Ethereum blockchain.

This contract allows the user to save and lock the latest state information, i.e. which is the latest state for the data set of the user. This contract can also be considered or known as a state contract because the state contracts are created and signed by the user before they are deployed in a process called offline transaction. These contracts deployed offline have unique data set keys for example the basic data set would have its own sets of Ethereum keys for signing the contract and deploying them. For reading the contract the contract address is required and the contract address further only reveals the latest user content hash for the data set.

Once the user downloads the data set, it would require the account encryption key to decrypt the data set, this entire process ensures if the user loses the existing device or has a new device the exact last state can be restored using account encryption keys.

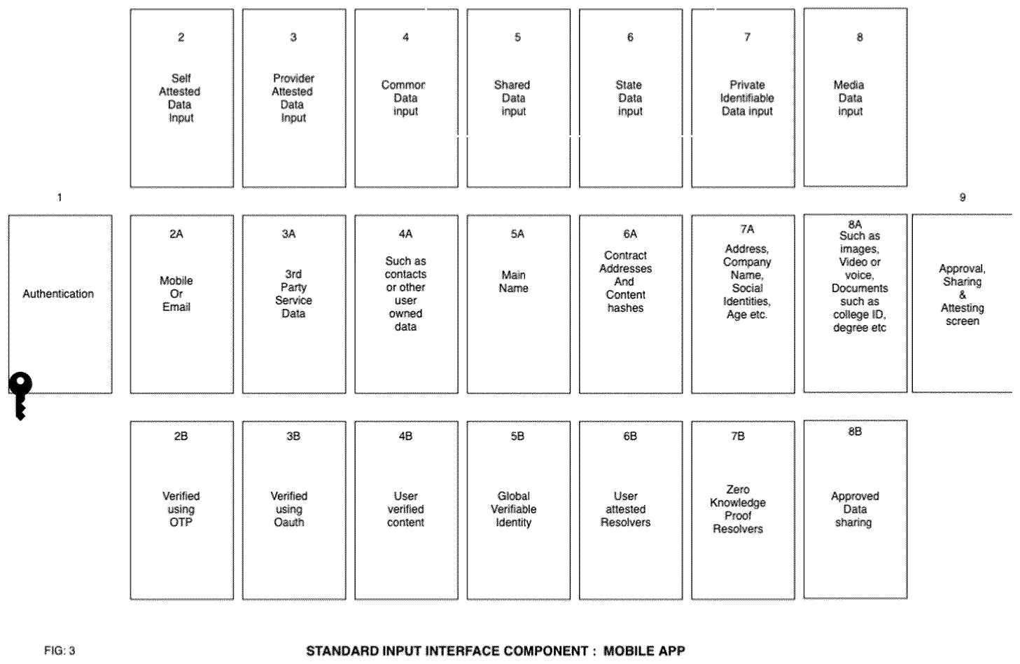

Data source has standard set of screens which are shown from logical perspective in FIG. 3 Authentication being the initial screen [1] and from there Data input types such [2, 3, 4, 5, 6,7,8] corresponding to the process [2A, 3A, 4A, 5A, 6A, 7A, 8A] and verification type associated with them in [2B, 3B, 4B, 5B, 6B, 7B, 8B]. Self attested data inputs 2 originate from the user such as email, or mobile and it is verified using one time passcodes. Similarly Provider Attested 3 some of them can be considered as accounts that users authenticate and verify using Auth v2.0 before saving them.

Common data input 4 such user owned contacts or other data types do not normally go through any verification process but instead manually or auto imported using the mobile user interface. Shared Data Input 5 are pre-shared information or available to be shared publicly such as use chosen Main Name and it is globally verifiable identity. State data inputs 6 as discussed earlier are unique contract addresses and content hashes which act as a resolver to retrieve, update and delete states. Private identifiable information 7 such as but not limited to: address, company name or social identities, age, etc. are available as zero knowledge proofs only.

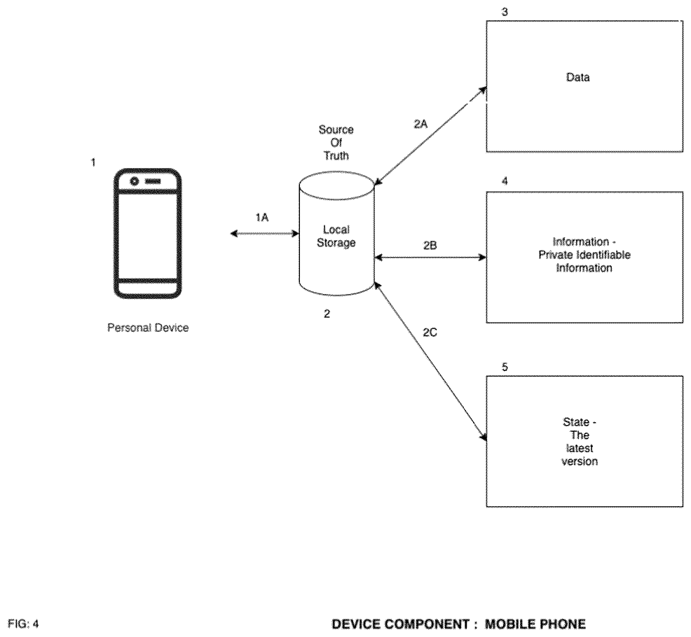

In the preferred embodiment, media data input 8 such as but not limited to: images, video or voice, documents (such as college id), driving license, etc. are only available through approved data sharing. Finally all these forms of methods go through either attestation, approval or sharing screen before the recipient can access them. User's device or mobile phone stores all the data in the local storage and as it is the source of truth it maintains the latest data set, information set and state set which is backend up is shown in FIG. 4 where mobile provides the data 3, information 4 and generates state 5. These are saved in the device local storage.

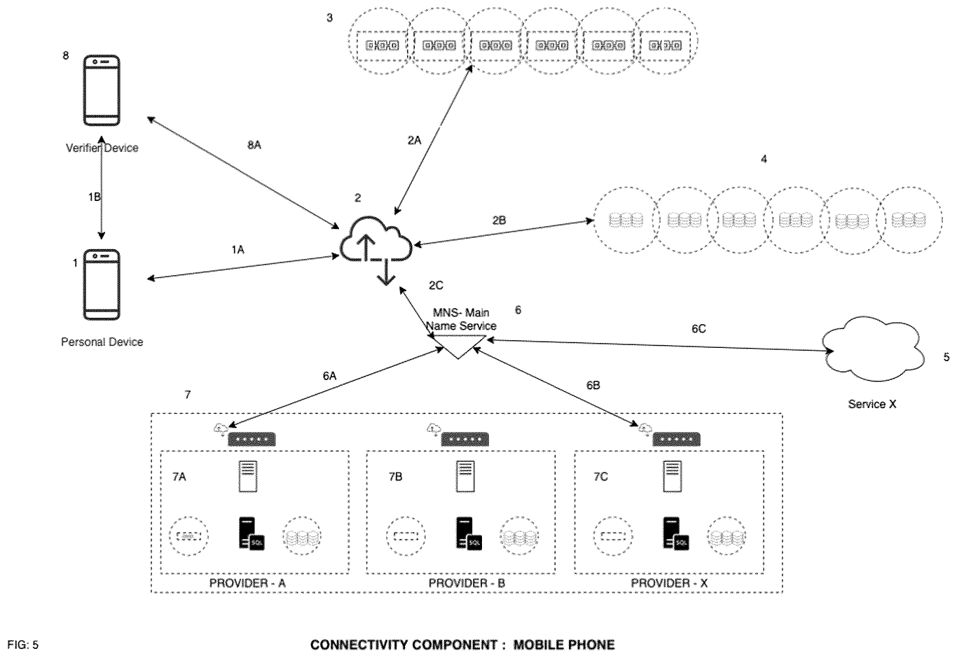

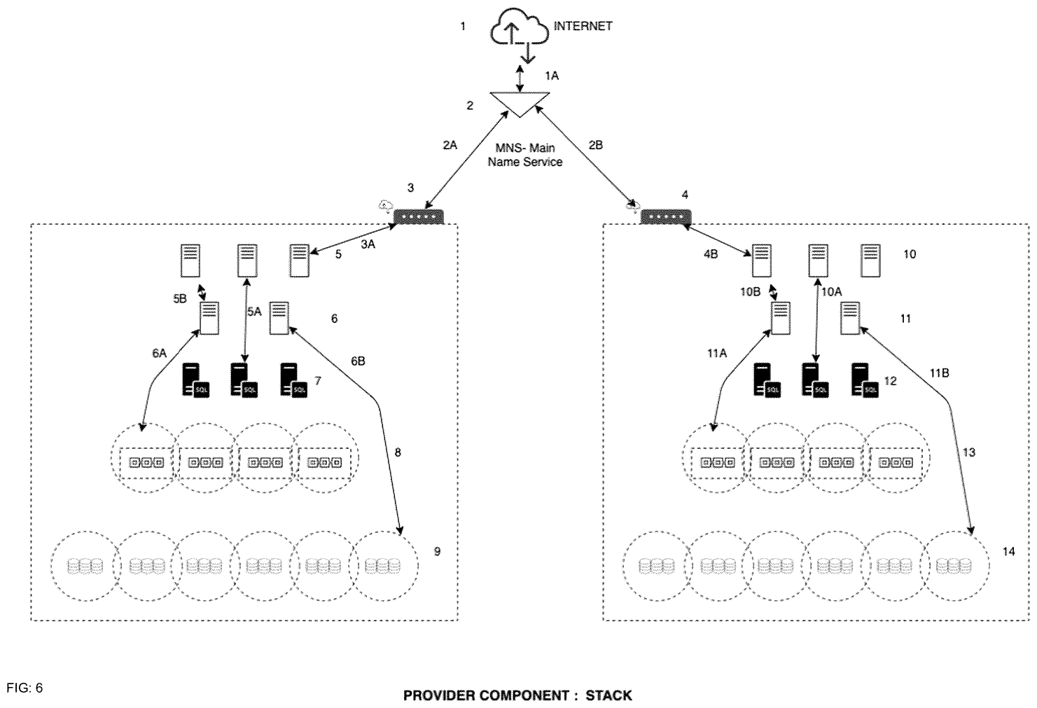

FIG. 5 shows the preferred embodiment, of the overall connectivity of the current invention, user's device 1 connects to the internet 1A for accessing public chain and reading public IPFS web profile while it also uses NFC (Near Field Communication) to share and verify credentials on blockchain. User's device talks to the provider stack using MNS[6] (Main Name service) which resolves to the closest provider for performing data operations discussed earlier such as pushing the latest encrypted state, etc. Inter-sync between the providers can be seen in 6A and 6B through custom peer to peer sync. Resolver also provides the ability to resolve other services using the public key of the service for other blockchains. Provider or the stack contains the following components: a private IPFS storage cluster 9 or 14 shown in FIG. 6, private Ethereum chain 8 or 13 in FIG. 6, SQL server 7 or 12, micro services which provides API to interact with private blockchain, private IPFS and web profile management on public IPFS 6 or 11 in FIG. 6.

Provider synchronization happens only between the stack providers or authorities part of running the stack, this synchronization as seen in the figure would happen using the peer to peer state and data synchronization service. The novelty of this service uses MNS to keep the network decentralized among many providers. Regardless of the network provider, the data can not be viewed by any of the said providers because the data is encrypted by the user account keys.

FIG. 6 in 5 or 10 shows the API controller for each stack which is available for the mobile application to interact with, this controller provides action such as authentication, verification, share management etc. API controller also acts as gateway to talk other internal stacks such as micro service to interact with IPFS and blockchain. User post authentication to the API controller has the ability to perform state operations such as but not limited to: backing up encrypted state, publishing web profile and private contract deployment etc. MNS (Main name service) acts as a resolver for picking the closest provider and as a resolver for various services such as wallet functionality.

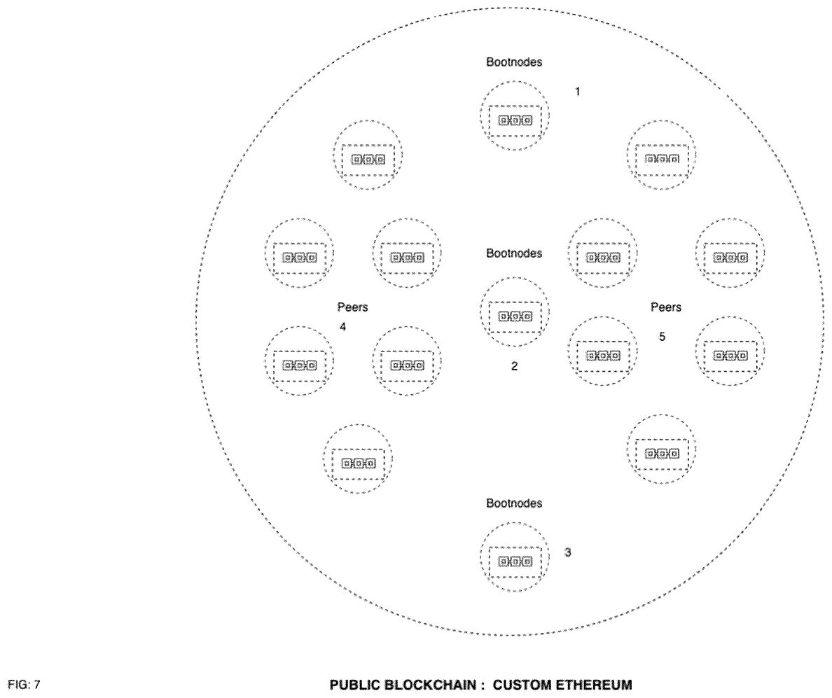

The preferred embodiment, public blockchain (Mainchain) FIG. 7 shows the availability of nodes along with initially deployed nodes (bootnodes), peers running the nodes continue to receive reward for mining using proof of work or any other consensus eventually moved to. Users have the ability to deploy decentralized identity contracts to this chain with the ability of verification, attestation and identification. In an alternative embodiment, this contract maybe managed directly from the user's device containing only public cryptographics keys as resolvers.

Main name is also the primary resolver to wallet services, Wallet service as Main allows the users to resolve wallet addresses using the recipient main name. Main Public contract allows users to self attest and deploy identities which does not contain any PII attributes instead only contains the ‘Sub Identity Resolvers’ which is public cryptographic keys.

In the preferred embodiment, users own their contract, allowing said users to self attest the identities they own and do not have authority to sign and attest such as blockchains that is not owned. Main Decentralized Identity acts as the primary resolver. Once a user shares the Main Decentralized Identity with anyone, it has the ability to resolve the Main name and similarly when a user shares the Main name with anyone it also sends the unique contract address (Main ID) to the user. This is running a smart contract deployed and managed by the user themselves allowing them to identify or verify.

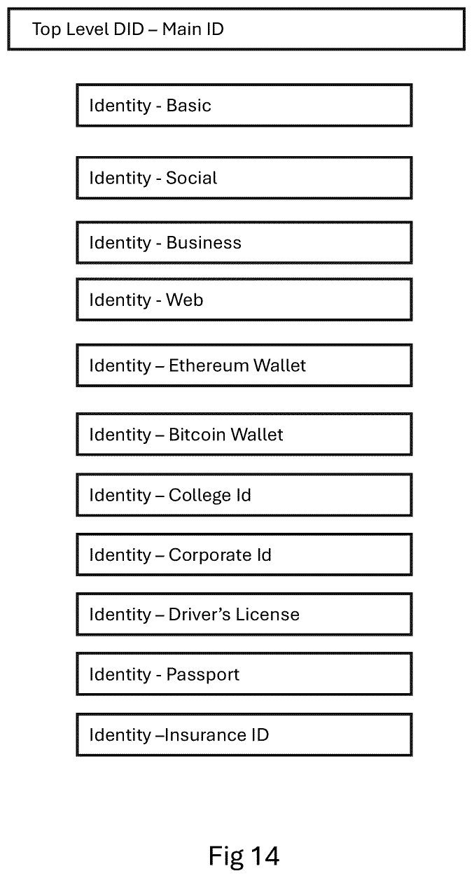

An additional novelty of this invention is that no one knows your main name unless you authorize or share it with anyone and this is when the associated decentralized address is shared. Main Decentralized Identity is a publicly available contract and can be accessed by anyone however it all starts once someone knows your main name which resolves to Main Decentralized Identity Contract. Main Decentralized Identity Contract contains various identities and these are resolvable using either by the service type, provider name, etc., this key which returns the public key of the relevant service/provider's value stored, as shown in FIG. 14. This is the simplest form of decentralized service which allows resolution of service and identity due to the user owned Main Decentralized Identity Contract. This service can be used to resolve relevant blockchain keys allowing the known users to resolve with just the Main Name.

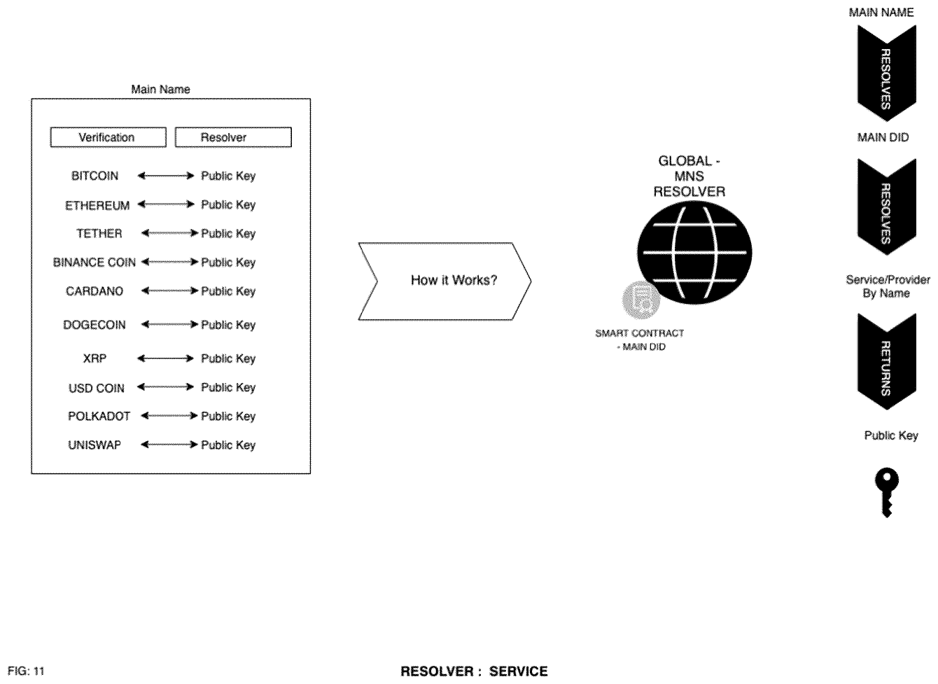

The FIG. 11 shows the resolver functionalities within the contract. Main Decentralized Identity Methods allows but is not limited to the following in the contract:
1) Has Identity
2) Specification Exists
3) Create Identity
4) Update Identity
5) Delete Identity
6) Get total identity count
7) Get Main Name by Address
8) Get address by Main Name
9) Verify and attest function example

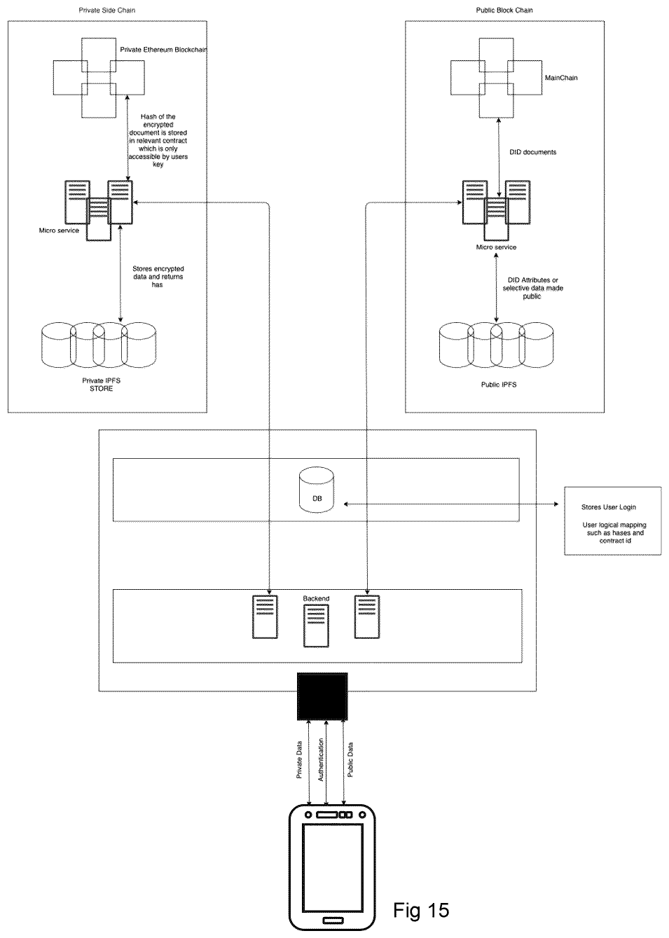

The complete data flow is shown in FIG. 15 which further breaks down the components of Main Stack and identifies what data is stored at which service.

Main Provider Stack Micro Service comprises the following application services:
1) Application Controller API
2) IPFS Private Nodes
3) Main SideChain Private Nodes

The functionality of application controller api are as followed:
1) Storing and retrieving encrypted content from private IPFS which holds the encrypted user data
2) Private contract deployment which stores the hash reference only resolvable by the user using their private keys

Both this functionality is designed in such a way that it allows CRUD operations (CREATE, READ, UPDATE and DELETE).

Main SideChain has the following two services, IPFS and Ethereum Private network; these two services together allow a unique mechanism to store, retrieve and resolve private encrypted data.

The encrypted data is stored for two purposes:
1) Allow users securely stored encrypted data but owned and controlled by themselves
2) To ensure always the latest state is available

The actual unencrypted data always stays on the user device and it is the source of truth at all times. IPFS nodes in this case allow mutation of data as the state changes and the data is not publicly available, this is done to ensure all Private Identifiable information is to be encrypted and stored on isolated silos rather than storing it on public domain.

IPFS allows the user to encrypt the data and push the encrypted state at all times, this ensures as long as the user has the private account to recover or restore the data on any new device.

Microservice written for IPFS provides the following functionality:
1) Add Private Data
2) Update Private Data
3) Read Private Data
4) Delete Private Data

All these methods return encrypted data to the user to decrypt with their own private key to know or reach the private data a user must have created content resolvers using the contract methods. Ethereum's private network allows users to deploy contracts for each identity or data set. Once the contract is created, The user can only read, update and delete the resolvers for private data. Thus making it impossible for anyone without access to the private account key or identity key to retrieve PII information unless it is owned by the user. All the identity contracts which contain PII are accessible by the user only.

What is important to note on the private contract is that only the contract owner has the ability to manipulate the content references thanks to the contract modifier function which validates “ifOwner” before allowing any manipulation. As it can be seen both the contracts are written in such a way that the user controls and owns the contract. Private IPFS stores users owned encrypted content, This is resolved using the private contract to find the unique content hash saved under user deployed contract on private Ethereum side chain as shown in the diagram and Public IPFS is used for user chosen public profile such as web profile information, Public side also stores user own DID contract deployed by the user for the purposes of verification, attestation, etc.

A decentralized and user controlled method for sharing secured user data comprising of: preventing service providers from unauthorized use or sale of user data; preventing large scale hacks from compromising user data; allowing unprecedented user control over said user data; and allowing user control of information based on recipient.

While the above invention has been described with reference to certain preferred embodiments, the scope of the present invention is not limited to these embodiments. One skilled in the art may find variations of these preferred embodiments which, nevertheless, fall within the spirit of the present invention, whose scope is defined by the claims set forth below

1. A decentralized and user controlled method for sharing secured user data comprising of:
preventing service providers from unauthorized use or sale of user data;
preventing large scale hacks from compromising user data;
allowing unprecedented user control over said user data; and
allowing user control of information based on recipient.
